(19) United States
(12) Patent Application Publication
(10) Pub. No.: US 2011/0156330 A1
(43) Pub. Date: Jun. 30, 2011

(54) PLATFORM AND METHOD FOR SUPPORTING A WORKPIECE TO BE CUT FROM SHEET MATERIAL

(76) Inventor: Michael William Gadd, Singapore (SG)

(21) Appl. No.: 12/294,745

(22) PCT Filed: Mar. 29, 2007
(86) PCT No.: PCT/SG2007/000085

§ 371 Date: Dec. 30, 2008

(30) Foreign Application Priority Data
Mar. 29, 2006 (SG) 200602079-6

(51) Int. Cl. B26D 7/01; B25H 1/00; B25B 11/00

(52) U.S. Cl. 269/21; 269/296; 269/295; 83/13

(57) ABSTRACT

A platform for supporting a sheet material having a workpiece portion to be cut is disclosed. The platform comprises one or more movable supports arranged to support the workpiece portion in a support position. The or each support is movable to a cutting position in which a cutting agent may cut the workpiece adjacent the support position without damaging the support.

The present invention relates to a platform and method for supporting a workpiece to be cut from sheet material. More particularly, the invention relates to a manipulation of one or more movable supports for the workpiece, the or each support being movable between support and cutting positions.

The cutting of predetermined shapes from a sheet material may be achieved by using a laser or fluid jet, or other cutting agents of the mechanical type, such as saws. When using the cutting agent to cut such material it is common to cut all the way through the sheet material with the cutting agent passing through the material from one side to the other. The sheet material is normally secured by a fixture which supports the sheet material to allow for the cutting agent to pass from one side to the other without the cutting agent damaging the fixture.

Problems can arise when it comes to holding the sheet material for cutting workpieces from it. Commonly assigned International Patent Application No. PCT/SG02/00297 proposes a method of cutting a product of a predetermined shape from a sheet material by supporting a sheet material in a first position by a first support means whereafter the sheet may be cut through by moving a line type cutter relative to the sheet material on a line or lines to define part of the predetermined shape. The sheet material is supported in a second position and again cut by moving a line type cutter relative to the sheet material on a line or lines to define the remaining perimeter of the predetermined shape, thereby to cut the predetermined shape from the sheet material. In the second position the sheet material is provided with upward support to support the predetermined shape to be cut from the sheet material and wherein in the second position the or another support means includes a through cut commensurate to the line or lines to define the remaining perimeter of the predetermined shape. However, this method does not lend itself particularly well to cutting irregular shapes from the sheet material.

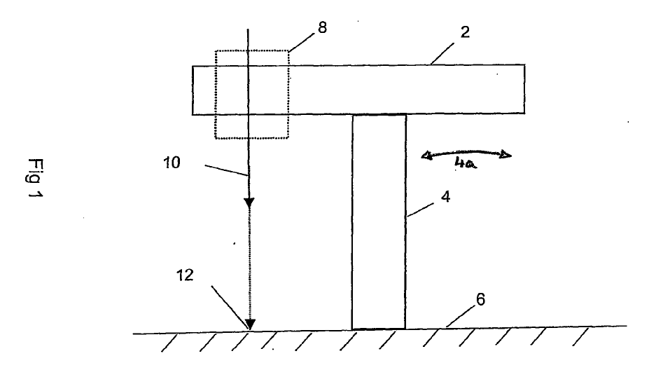

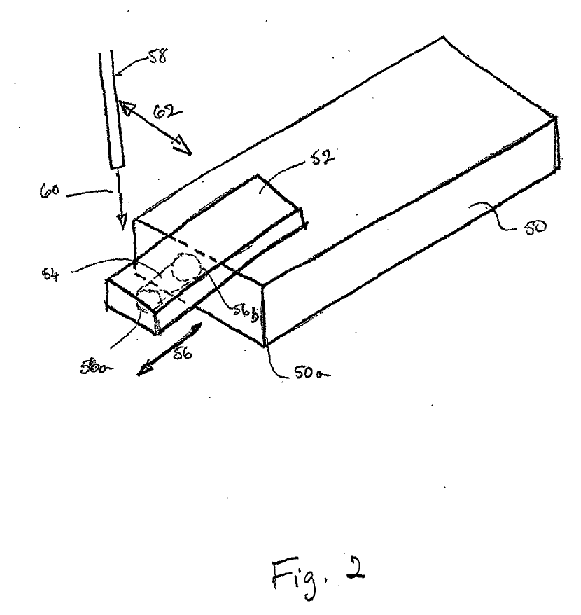

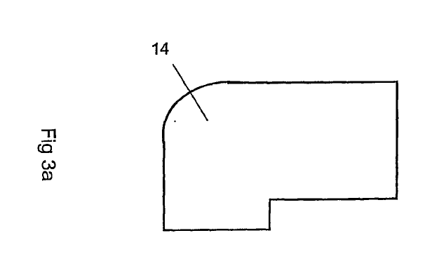

The present applicant considered a solution to this problem as illustrated in FIG. 1.

As shown in FIG. 1, the sheet material 2 which is to be cut by a cutting agent is supported on an elongate columnar support 4 which itself rests upon a base 6. The cutting agent may act upon the sheet material at a workpiece portion 8 by cutting and using, for example, a laser, water jet or other cutting agent in the direction 10 as shown. The cutting agent is moved relative to the sheet material 2 (by moving the cutting agent and/or rotating the support 4) to cut the predetermined shape from the workpiece 8. However, problems still arise in that the columnar support 4 is, from necessity, of a small cross section in order that cut out shapes from the sheet material may be small, such as SIM (subscriber identity module) cards for mobile phones. Further, to attempt to ensure that damage to the base 6 from the cutting agent is minimised, the columnar support 4 length is determined so that the energy of the cutting agent (when, for example, a jet) is dissipated at the point of contact with the base. As such, the columnar support 4 is unstable, subject to lateral movement in the direction 4a. Thus, support of the sheet material 2 is not stable. To ensure stability, the length of the support 4 must be minimised, but the action 10 of the cutting agent generally is not dissipated after passing through the workpiece portion 8 or sheet material 2 in the direction 10 as shown. Because of this, and the force of the cutting agent at point 12 on the base 6, damage may occur to the base.

It is an object of embodiments of the present invention to alleviate these problems.

The invention is defined in the independent claims. Some optional features of the invention are defined in the dependent claims.

By having a movable support, movable from a support position in which the workpiece is supported to a cutting position, the cutting agent may cut the workpiece adjacent (i.e. at or near) the support without damaging the support. In embodiments of the invention which implement only a single movable support, other non-movable supports may be used in conjunction with the movable support to support the workpiece when the movable support is in the cutting position. Embodiments of the invention utilise a plurality of movable supports, each of which function independently in the same way. Accordingly, a holding mechanism for the workpiece and sheet material may be greatly simplified. Further, embodiments of the invention allow for a complete cut out of the workpiece portion to be effected efficiently and cheaply without damaging any of the supports or the base. As one or more movable supports are used, the workpiece portion may be spaced sufficiently far from a base such as the base 6 in FIG. 1 or other support in order that damage to the base may be limited or avoided completely.

Embodiments of the invention provide a support for supporting a workpiece which has a hollow portion for allowing a vacuum to be selectively pulled through the hollow portion to exert a retaining force on the workpiece thereby to retain the workpiece in a predetermined position. This feature is particularly advantageous by utilising an existing support which is required for the process to provide an additional retention function without the mechanical problem of introducing vacuum pulling means adjacent the workpiece. This feature is also provided independently.

The present invention will now be described by way of example only and with reference to the accompanying drawings and which:

FIG. 1 is an elevational view of a system for supporting a sheet material for cutting an irregular-shaped workpiece from the sheet material;

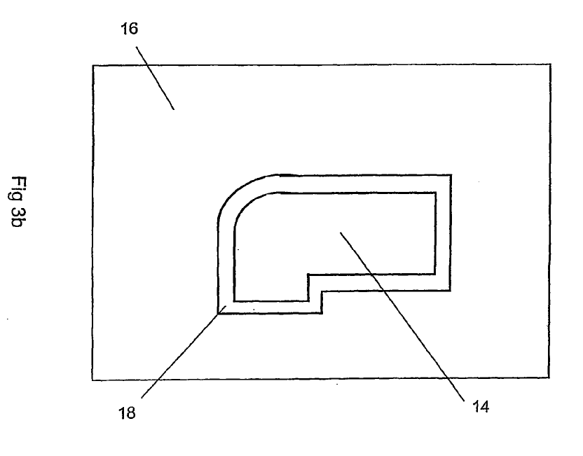

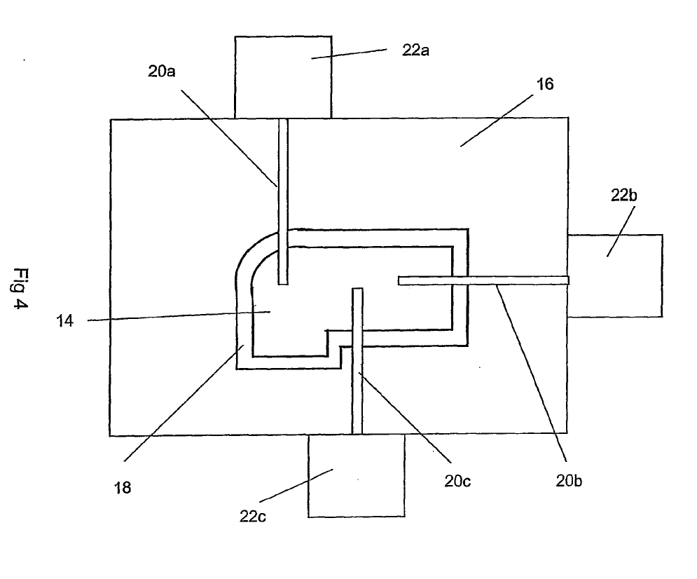

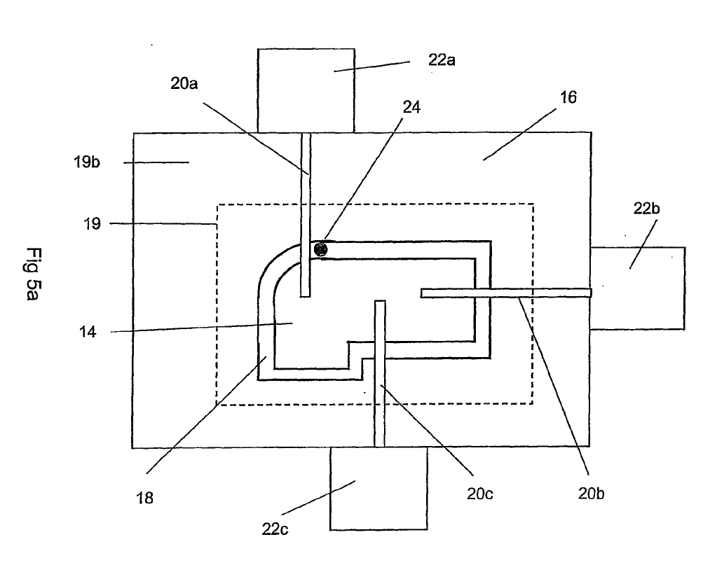

FIG. 2 is a diagram illustrating a platform according to an embodiment of the invention;

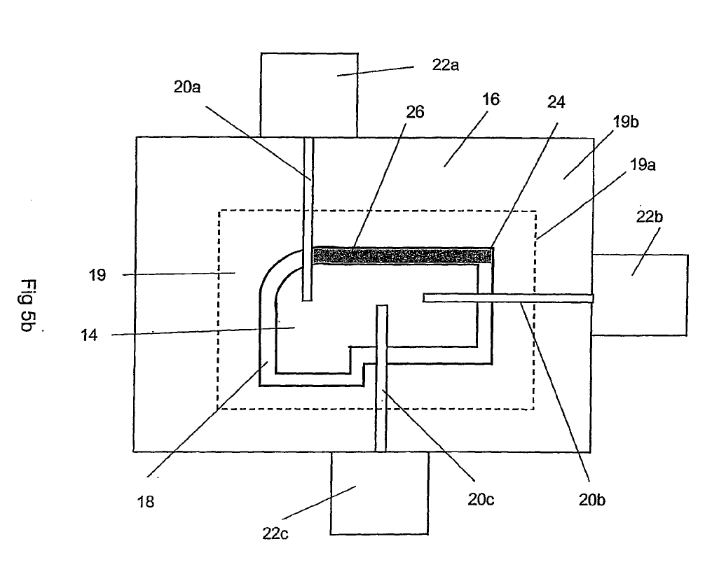

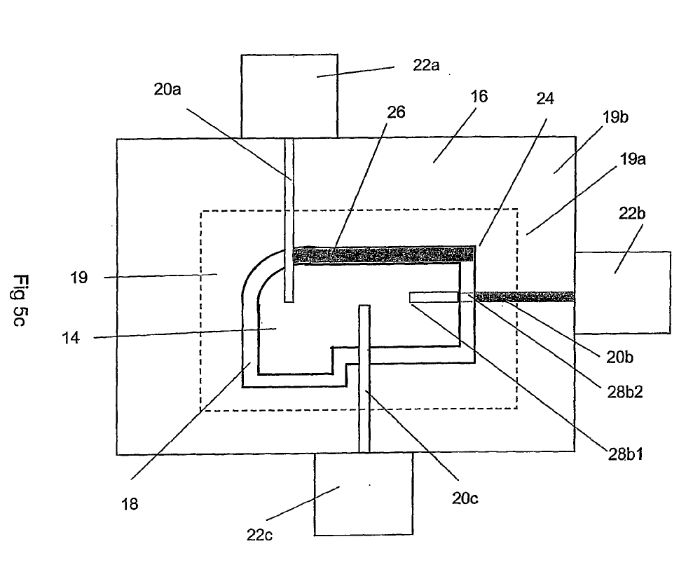

FIG. 3 is a diagram illustrating a typical workpiece to be cut from the sheet material;

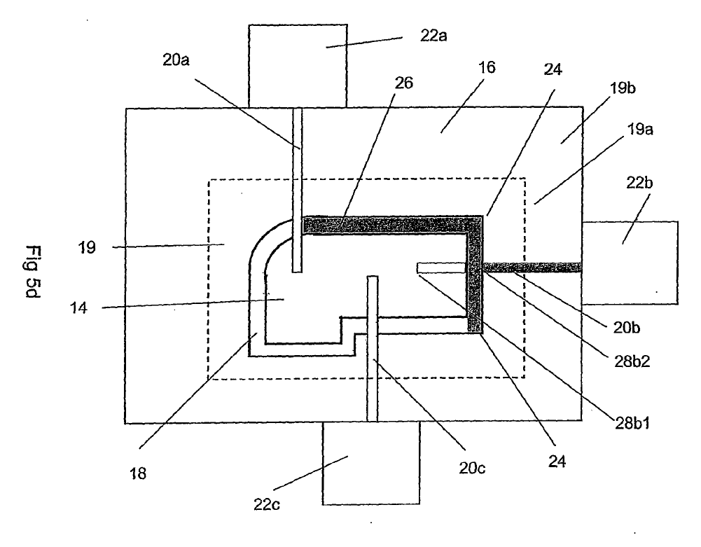

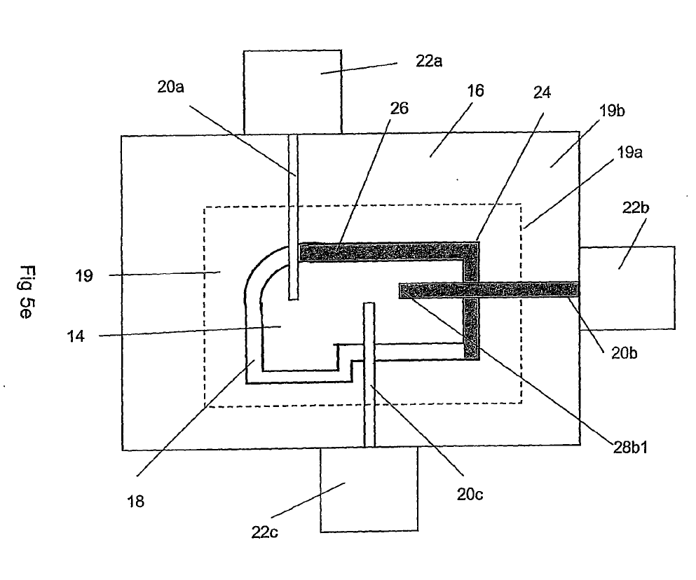

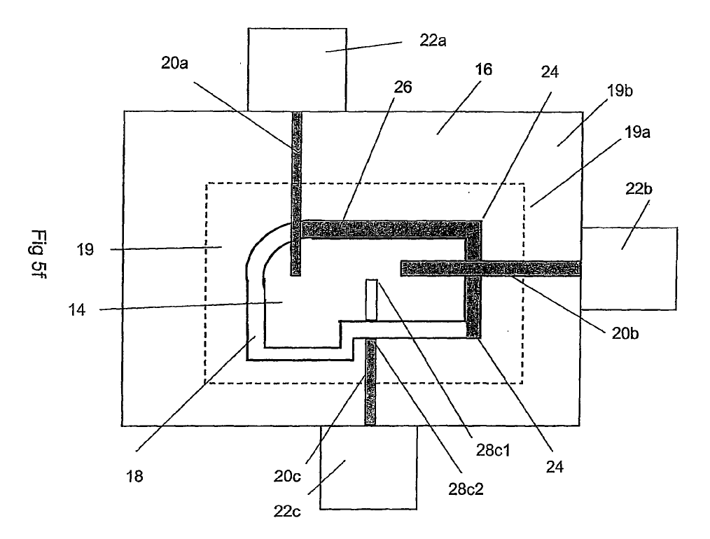

FIG. 4 is a diagram illustrating a platform according to an embodiment of the present invention;

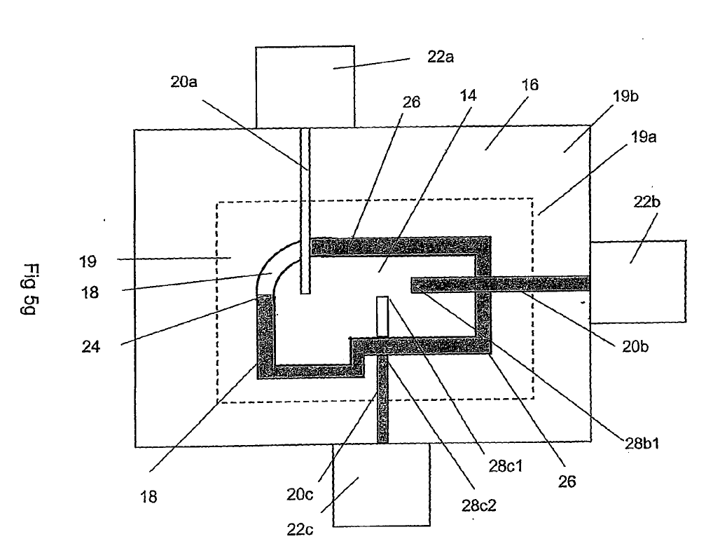

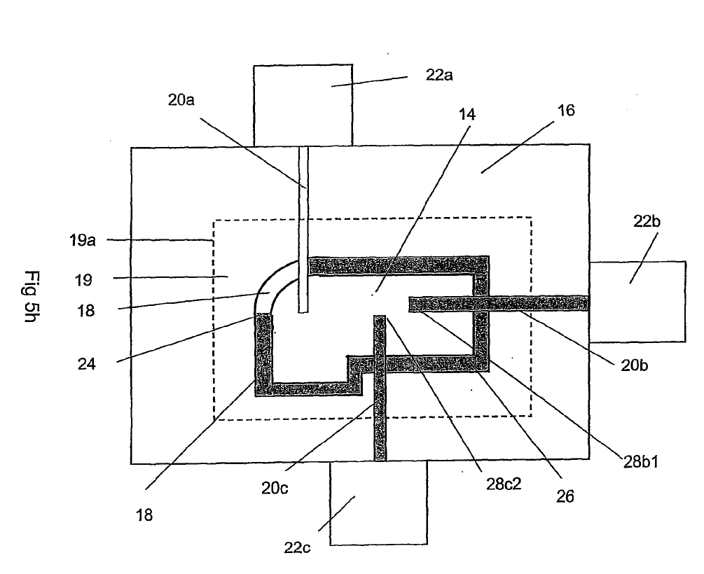

FIG. 5 illustrates a sequence of events of the cutting process for cutting the workpiece utilizing the embodiment of FIG. 4;

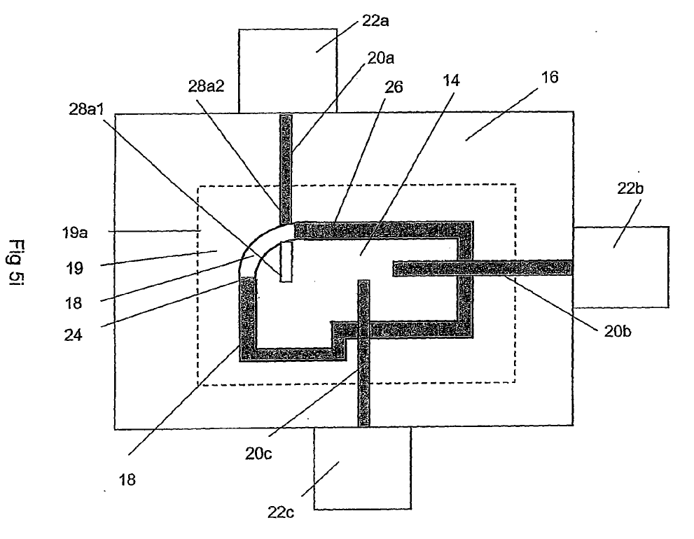

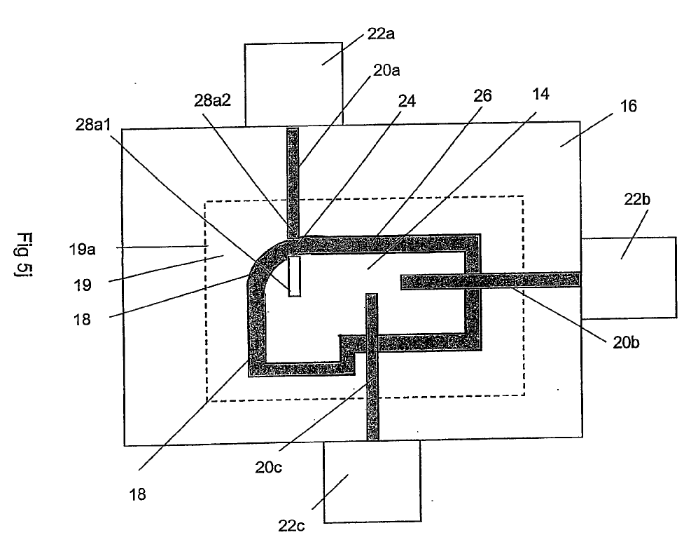

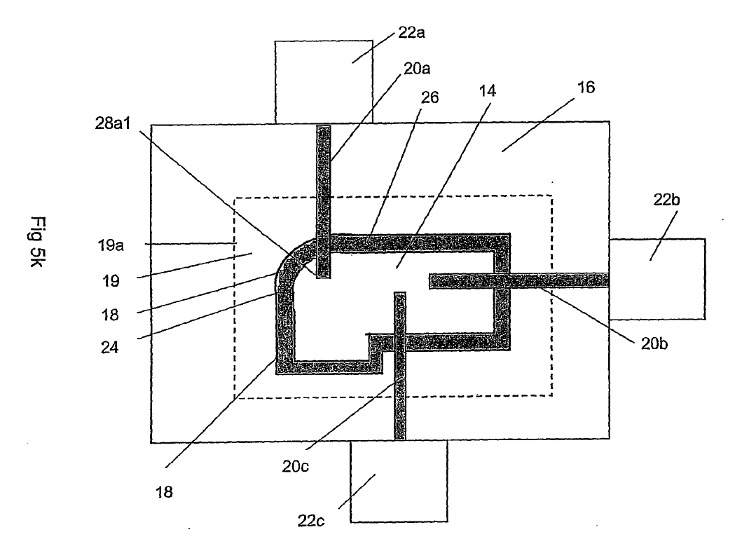

FIG. 6 is a diagram illustrating another embodiment of the present invention; and

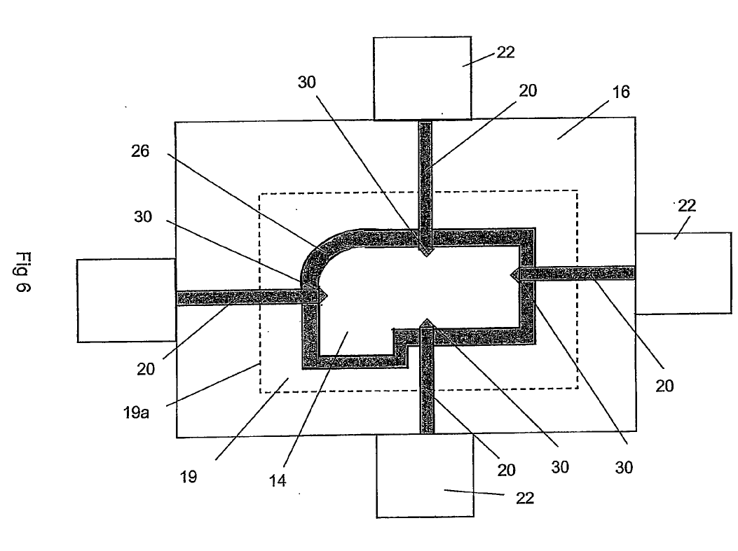

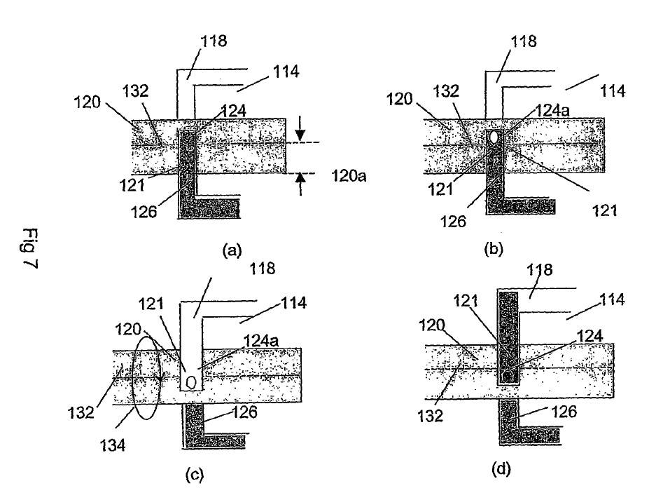

FIG. 7 is a diagram illustrating a further embodiment of the present invention.

FIG. 2 illustrates an embodiment of the invention. A platform 50 for supporting a sheet material 52 is illustrated in perspective. The workpiece 52 is supported by retractable support 54, movable in the axis 56. Cutting agent 58 is arranged to provide a cutting action 60 and is movable in the directions 62 as illustrated. In the illustrated embodiment, cutting agent 58 is a water jet cutter, ejecting a fine jet of water 60 downwards towards the sheet material 52, to cut a workpiece portion thereof. Support 54 is movable between a support position 56a in which the sheet material and workpiece are supported and a cutting position 56b in which the support 54 is moved to allow the cutting agent 58 to move in the direction 62 to cut the sheet material 52 without damaging the support 54; that is, the cutting agent 58 may pass adjacent the support position 56a (i.e. the position in which the support 54 supports the workpiece 52) without damaging support 54 as it is withdrawn from the cutting path. In embodiments of the invention, the cutting position 56b of the support 54 is a position in which the support 54 is retracted or withdrawn completely to or beyond the edge 50a of the platform 50. In embodiments, when the support 54 is moved to the cutting position 56b, the sheet material is retained in position by a second support (omitted for the purposes of clarity). Embodiments allow for the second support to be movable in the same fashion as support 54 or to be fixed.

It will be readily appreciated that, alternatively or additionally, the platform is movable and the cutting agent is stationary in embodiments.

Referring now to FIG. 3, a typical product to be cut from a sheet material will be described. FIG. 3a illustrates a cut out 14 from a semiconductor substrate. In the example of FIG. 3a, cut out 14 is a SIM card produced for a mobile communication device. As shown in FIG. 3b, the workpiece 14 has to be cut from the sheet material 16 along the cut template 18.

FIG. 4 illustrates an embodiment of the present invention. FIGS. 4, 5 and 6 show views from an underside of the platform and illustrate an embodiment of the invention in which the platform is situated in the horizontal plane. (It will be readily apparent to a skilled person that the principles of the invention may also be applied when the platform is situated in the vertical plane or inclined, at an angle, subject to suitable positioning of the support(s).) FIG. 4 illustrates a portion of sheet material 16 and a workpiece 14 to be cut out in the shape defined by the cutting template 18. The platform comprises in this embodiment three supports which are retractable pins 20a, 20b and 20c.

The sequence of manipulation of the individual retractable supports 20 will now be discussed with reference to FIG. 5. In FIG. 5a, retractable supports 20a, 20b and 20c are driven or actuated by driving mechanisms/actuators 22a, 22b and 22c respectively. The drive mechanism may be any suitable drive mechanism such as a servomotor or solenoid. The platform comprises an aperture 19 against which the workpiece is located. Any energy from the cutting agent not dissipated by the cutting action will therefore not harm the platform. The cutting agent 24 (which, as in the example of FIG. 2, is a water jet) is located to cut along the cutting template 18 to cut out the workpiece 14 from the sheet material 16. Referring now to FIG. 5b, the cutting agent 24 moves from left to right in the sense of FIG. 5b along the cutting template 18 leaving the cutting trail 26. In FIG. 5c, actuator 22b is actuated to retract support pin 20b from support position 28b1 along a longitudinal axis of the support beyond an edge of the aperture 19a (in which the support 20b provides a support function to the workpiece 14) to adjacent a solid portion 19b of the work surface in position 28b2 withdrawn from the workpiece 14. In this embodiment, the workpiece is supported in place by supports 20a and 20c while support 20b is in the withdrawn position. Referring now to FIG. 5d, cutting agent 24 travels along the cut template 18 and across the support position of retractable support 20b, which is now safely retracted away from the support position; the cutting agent 24 has passed across without damaging support 20b. FIG. 5e shows re-actuation of the actuator 22b to move the tip of the end of the support 20b so that the tip of the support 20b is re-deployed to the support position 28b1, again offering support to the workpiece 14.

Referring now to FIG. 5f, the process described in relation to support 20b is repeated for support 20c and the support 20c is retracted by actuation of actuator 22c to retract support 20c from the support position 28c1 to the retracted or withdrawn position 28c2. In FIG. 5g, it can be seen that as the support 20c is withdrawn to position 28c2, the cutting agent 24 is able to trace a cut 26 along cut template 18 past support position 28c1 without damaging the support 20c.

FIGS. 5h, 5i, 5j, and 5k demonstrate the manner in which the process is repeated for support 20a to retract support 20a from support position 28a1 to cutting position 28a2 to allow the cutting agent 24 to complete the cut trail 26 along the cut template 18, thereby providing the cut out 14 of the workpiece product from the sheet material 16.

The supports extend from a solid portion 19b of the work surface beyond an edge 19a of the aperture 19. Thus, the supports 20a, 20b and 20c may support the workpiece 14 when it is completely cut out and the workpiece will not fall through the aperture.

Embodiments of the invention provide a support with a hollow portion, the hollow portion exiting the support at an aperture against which the workpiece is to be located. This allows for the application of a vacuum to be selectively pulled through the hollow portion of one or more of the supports 20a, 20b and 20c to the aperture thereby to exert a retaining force on the workpiece to retain the workpiece in a predetermined position. Any suitable means such as a vacuum pump (not shown) can be provided as a means of pulling the vacuum in the hollow portion of the pin. Embodiments of the invention allow for only one support to have the hollow portion to allow for the last remaining support held in place to retain the workpiece whilst one or more other supports are withdrawn. In embodiments where the workpiece is not located in the horizontal plane, the feature of pulling a vacuum through one or more supports may be particularly advantageous in holding the workpiece portion in a predetermined position against the action of, e.g., gravity.

Additionally or alternatively, the workpiece may be releasably engaged by engaging means 30 on the retractable support 20. In the example of FIG. 6, the engaging means 30 comprise conical projections on the end of the support 20 for engaging the workpiece releasably. To release the workpiece from the engagement, the support 20 is retracted by the actuator 22 (retracted position not shown).

A further embodiment of the invention is illustrated with reference to FIG. 7 in which the sequence of events for the cutting operation of this embodiment is illustrated. FIG. 7a shows a support pin 120 having a slot 121. The support pin 120 has a longitudinal axis 132. In the embodiment of FIG. 7, a depth of the slot 121 within the support pin 120 is greater than a radius 120a of the cross-section of the support pin 120; that is, the slot 121 extends from an outside surface of the support 120 across the longitudinal axis 132. (Alternatively, the length of the slot 121 may be equal to or less than the radius of the cross-section of the support 120.) In this embodiment, workpiece 114 is to be cut from the sheet material by the cutting agent 124 passing along cutting template 118 to leave a cutting trail 126.

Cutting agent 124 is operated to cut along cutting template 118 and to pass across the cutting trail and through slot 121. In this way, the cutting agent passes partially across the support position without damaging the support; the cutting agent simply passes through slot 121.

With reference to FIG. 7b, the cutting action of cutting agent 124 is switched off (e.g. the water jet is switched off), as denoted by 124a. Thus, support pin 120 is rotated (denoted by 134—see FIG. 7c), for example, 180 degrees about longitudinal axis 132 by an actuator (not shown) so that the support pin 120 is moved to the cutting position. This arrangement allows the cutting agent 124 to be moved across the support position, completing the cutting action. As the length of the slot 121 is greater than the radius of the cross-section of the support pin 120, in the rotated position (cutting position) the cutting agent when switched off 124a is still directed towards the slot meaning that, when the cutting action of cutting agent 124 is switched back on—see FIG. 7d—the cutting action simply passes through slot 121 in the rotated cutting position and support 120 remains undamaged by the cutting agent 124. Thus, the cutting agent 124 may complete the cutting trail 126 past the position of the support pin 120 along cutting template 118.

It will be appreciated that the present invention has been described by way of example only and variations of the described examples may be made but remain within the spirit and scope of the invention. Features of one aspect of the invention may be provided in combination with features of any other aspect of the invention.

1. A platform for supporting a sheet material having a workpiece portion to be cut, the platform comprising a support movable between a support position in which the workpiece portion is supported and a cutting position in which a cutting agent may cut the workpiece adjacent the support position without damaging the support.

2. A platform according to claim 1, the platform comprising a plurality of supports, each of the supports being independently movable between respective support positions in which the workpiece portion is supported and respective cutting positions in which the cutting agent may cut the workpiece adjacent the respective support positions without damaging the respective support.

3. A platform according to claim 1 or claim 2, the or each support being arranged to move to the or each respective cutting position to allow the cutting agent to cross the or each respective support position without damaging the or each support.

4. A platform according to any preceding claim, wherein the or each support is arranged to move along a longitudinal axis of the support from the support position to the cutting position.

5. A platform according to any preceding claim, wherein the platform comprises a work surface having an aperture for locating the workpiece portion against and the or each support is movable from the or each respective support position adjacent a solid portion of the work surface to the or each respective cutting position extending beyond an edge of the aperture.

6. A platform according to any of claims 1 to 3, wherein the or each support comprises a slot through which the cutting agent may pass without damaging the or each support, the or each support being arranged to move from the support position to the cutting position by rotating in a longitudinal axis of the support.

7. A platform according to any preceding claim, wherein a first support comprises a hollow portion with an aperture for locating the workpiece portion against, the support being arranged to allow a vacuum to be selectively pulled through the hollow portion, thereby to exert a retaining force on the workpiece to retain the workpiece in a predetermined position.

8. A platform for supporting a sheet material having a workpiece portion to be cut, the platform comprising a first support having a hollow portion with an aperture for locating the workpiece portion against, the support being arranged to allow a vacuum to be selectively pulled through the hollow portion, thereby to exert a retaining force on the workpiece to retain the workpiece in a predetermined position.

9. A platform according to any preceding claim, wherein the or each support comprises engaging means for releasably engaging with the workpiece.

10. A method of cutting a workpiece portion from a sheet material, the method comprising:
locating the workpiece adjacent a work surface of a platform for supporting the sheet material;
cutting the workpiece with a cutting agent;
moving a support on the platform from a support position in which the workpiece portion is supported to a cutting position in which a cutting agent may cut the workpiece adjacent the support position without damaging the support.

11. A method according to claim 10, the method comprising independently moving each of a plurality of supports from respective support positions in which the workpiece portion is supported to respective cutting positions in which the cutting agent may cut the workpiece adjacent the respective support positions without damaging the respective support.

12. A method according to claim 10 or claim 11, the method comprising moving the or each support to the or each respective cutting position to allow the cutting agent to cross the or each respective support position without damaging the or each support.

13. A method according to any of claims 10 to 12, wherein moving the or each support comprises moving the support along a longitudinal axis of the support from the support position to the cutting position.

14. A method according to claim 12 when dependent on claim 11, the method comprising moving the plurality of supports in a predetermined sequence, thereby to allow the cutting agent to cut the workpiece without damaging the supports.

15. A method according to any of claims 10 to 14, the method further comprising locating the workpiece adjacent an aperture in the work surface and moving the or each support from the or each respective support position adjacent a solid portion of the work surface to the or each respective cutting position extending beyond an edge of the aperture.

16. A method according to any of claims 10 to 12, wherein cutting the workpiece with the cutting agent comprises cutting partially across the support position, and allowing the cutting agent to pass through a slot in the support without damaging the support and wherein moving the or each support from the support position to the cutting position comprises stopping a cutting action of the cutting agent and rotating the or each support in a longitudinal axis of the support to the cutting position.

17. A method according to claim 16, the method further comprising restarting the cutting action of the cutting agent to continue cutting, and allowing the cutting agent to pass through the slot without damaging the support.

18. A method according to any of claims 10 to 17, wherein the method further comprises selectively pulling a vacuum through a hollow portion of a first support, the aperture being located against the workpiece portion, thereby to exert a retaining force on the workpiece to retain the workpiece in a predetermined position.

19. A method for supporting a sheet material having a workpiece portion to be cut, the platform comprising a first support having a hollow portion with an aperture for locating the workpiece portion against and selectively pulling a vacuum through the hollow portion, thereby to exert a retaining force on the workpiece to retain the workpiece in a predetermined position.

20. A method according to any of claims 10 to 19, the method comprising releasably engaging the workpiece with engaging means on the or each support.
